(19) United States
(12) Patent Application Publication
(10) Pub. No.: US 2012/0059974 A1
(43) Pub. Date: Mar. 8, 2012

(54) METHOD AND APPARATUS FOR IMPROVING COMPUTER SYSTEM PERFORMANCE BY ISOLATING SYSTEM AND USER DATA

(76) Inventor: Sai Krishna Mylavarapu, Folsom, CA (US)

(21) Appl. No.: 12/874,724

(22) Filed: Sep. 2, 2010

(51) Int. Cl. G06F 12/02

(52) U.S. Cl. 711/103; 711/E12.008

(57) ABSTRACT

An apparatus comprising a logic unit to separate system data and user data from host data to be processed by a processor; a first memory to store the system data separated by the logic unit; and a second memory to store the user data separated by the logic unit, wherein the first memory is a non-volatile memory which is physically located closer to the processor than the second memory.

### FIELD OF THE INVENTION

Embodiments of the invention relate generally to storage architectures in a computer system. More particularly, embodiments of the invention relate to a method and apparatus for improving computer system performance by isolating system and user data for storage in separate memories.

### BACKGROUND

As computer processing increases, the performance of typical computer storage architectures is degraded. The term “performance” herein refers to the attributes of a computer system including power consumption of a computer storage architecture, boot-up and wake-up times of the computer storage architecture, user data bandwidth on the bus coupling the secondary memory to the host processor, cost of the computer storage architecture, etc. Degraded or lower performance of typical computer storage architecture is caused, among several reasons, by randomly bundled system and user data which are stored in large secondary memories (e.g., hard drives). Such bundled system and user data means that the microprocessor of the computer storage architecture spends significant processing time to locate and separate system data from the randomly bundled system and user data, further increasing power consumption of the typical computer storage architecture.

FIG. 1 illustrates a typical computer system storage architecture 100. The host processor 101 which consists of a microprocessor 107, coupled to a local memory 106 such as a Dynamic Random Access Memory (DRAM), processes both system and user data. The term “system data” herein refers to metadata having content of a file system including page files that inform an operating system where user data is located in a memory, page tables, etc. The term “user data” herein refers to all other data other than system data and is generally larger in size than system data.

The typical computer system 100 also consists of a chipset processor 108, coupled to the microprocessor 107, to communicate with an external memory 102 via a Serial Advance Technology Attachment (SATA) input-output (I/O) Interface or the Serially Attached Small System Computer (SAS) input-output (I/O) Interface bus interface 103. The SATA or SAS I/O bus interface 103 interfaces the host processor 101 via a host bus adaptor 109. The typical computer system 100 further consists of an external memory 102 (external to the host processor 101) which is also known as the secondary memory. The external memory 102 is generally an electro-mechanical hard-drive. The memory regions in the secondary memory 102 that are randomly spread in the secondary memory 102 memory contain system data 104. The remainder space of the secondary memory 102 is the memory region for containing user data 105.

In a typical computer system, most data traffic between the host processor 101 and the secondary memory 102 are read and write operations of file system content, which are part of system data 104. These frequent accesses (read and write operations) of the file system content include page file swapping that results in power consumption by the secondary memory 102. The frequent accesses of the file system content also results in excessive data traffic on the SATA or SAS I/O bus interface 103 and the host bus adaptor 109. The excessive data traffic is caused by the chipset processor 108 to identify the randomly placed system data in the secondary memory 102 from the user data 105, for processing of the system data 104 (e.g., page file data) by the chipset processor 108. Such frequent access of the secondary memory 102 lowers the performance of the computer system storage architecture. If the secondary memory 102 is a solid state drive (SSD), such frequent access of the secondary memory 102 reduces the performance of the computer system storage architecture, increases the power consumption of the computer system storage architecture, and reduces the life span of the SSD.

### BRIEF DESCRIPTION OF THE DRAWINGS

Embodiments of the invention will be understood more fully from the detailed description given below and from the accompanying drawings of various embodiments of the invention, which, however, should not be taken to limit the invention to the specific embodiments, but are for explanation and understanding only.

FIG. 1 illustrates a typical computer storage architecture with bundled system and user data.

FIG. 2 illustrates a computer storage architecture with separate memories for system and user data and logic to separate such data from host data, according to one embodiment of the invention.

FIG. 3A illustrates a flowchart to separate system and user data from host data, according to one embodiment of the invention.

FIG. 3B illustrates a flowchart to separate system and user data from host data, according to another embodiment of the invention.

FIG. 4 illustrates a computer system with machine-readable instructions to perform methods of FIGS. 3A-B, according to one embodiment of the invention.

### DETAILED DESCRIPTION

Embodiments of the invention relate to a method and apparatus for improving computer system performance by isolating system and user data from host data for storage in separate memories.

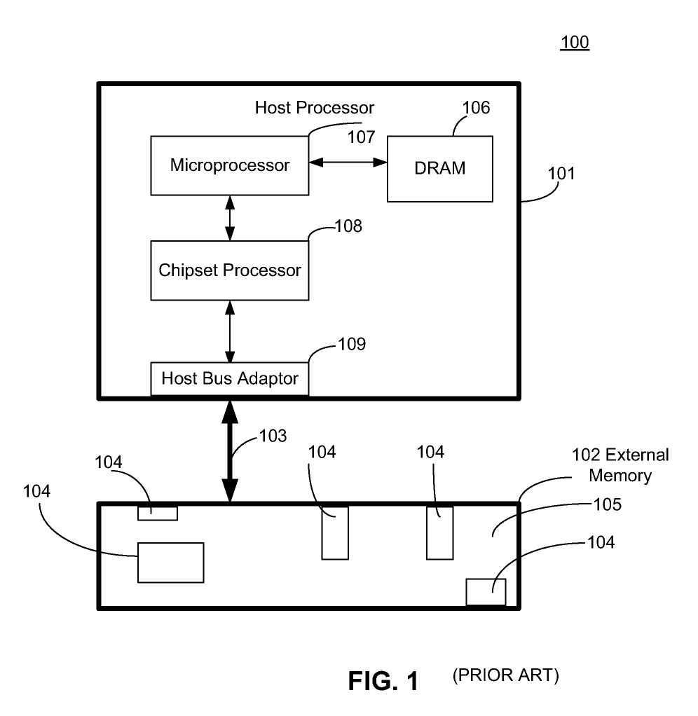

In one embodiment, the system data (e.g., page files, page tables, etc.) are stored in a first memory which is physically closer to a microprocessor and/or a chipset processor of a host processor. In one embodiment, the host processor comprises a first memory. In one embodiment, the system data which is typically smaller than the user data is separated from the host data and stored in the first memory while the user data is stored in a second memory e.g., a hard drive. By separating the system data and the user data from the host data and placing the system data closer to the processors that process the system data on a frequent basis, overall performance of the computer storage architecture is improved. In one embodiment, the performance of the computer storage system described herein improves by 16% compared to the typical computer storage system 100 of FIG. 1. The above performance improvement percentage is not a limiting performance improvement percentage.

In the following description, numerous details are discussed to provide a more thorough explanation of embodiments of the present invention. It will be apparent, however, to one skilled in the art, that embodiments of the present invention may be practiced without these specific details. In other instances, well-known structures and devices are shown in block diagram form, rather than in detail, in order to avoid obscuring embodiments of the present invention.

Note that in the corresponding drawings of the embodiments signals are represented with lines. Some lines may be thicker, to indicate more constituent signal paths, and/or have arrows at one or more ends, to indicate primary information flow direction. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme, e.g., Peripheral Component Interconnect (PCI) express, non-volatile memory host computer interface (NVMHCI) differential ended scheme, single-ended scheme, etc.

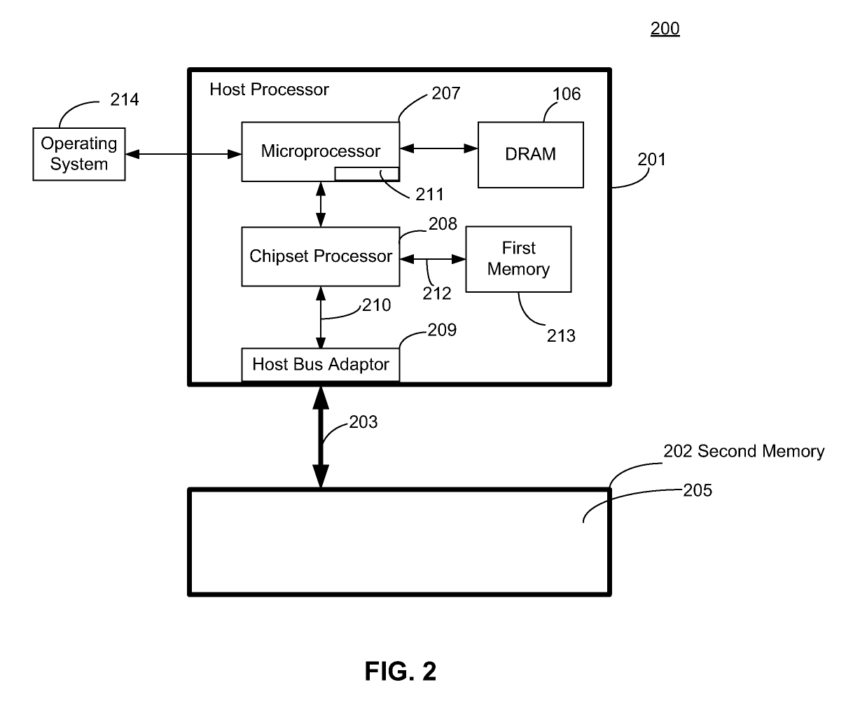

FIG. 2 is a computer storage system/architecture 200 with separate memories for storing system and user data and logic to separate such data from host data, according to one embodiment of the invention. The term “computer storage system/architecture” is interchangeably referred herein as “computer system.” In one embodiment, the computer system 200 comprises a host processor 201 coupled to a second memory 202 via a bus 203. In one embodiment, the host processor 201 includes a microprocessor 207 with a logic unit 211 which is operable to separate system data and user data from host data. In one embodiment, an operating system 214 is operable to instruct the logic unit 211 to separate the system data and the user data.

In the embodiments discussed herein, the system data is stored in a first memory 213. In one embodiment, the first memory 213 is integrated on the host processor 201. In one embodiment, the first memory 213 is a non-volatile memory. In one embodiment, the first memory 213 comprises a NAND flash memory, a NOR flash memory, a Phase Change Memory (PCM), or any other non-volatile memory. In one embodiment, the physical size (form structure) and the memory size of the first memory 213 is smaller than the physical size (form structure) and the memory size of the second memory 202.

In one embodiment, the first memory 213 is coupled to a chipset processor 208 via a non-volatile memory host computer interface (NVMHCI). In other embodiments, other types of interfaces may be used to communicate with the first memory 213. While the embodiment of the host processor 201 illustrates a chipset processor 208 separate from the microprocessor 207, the components of the host processor 201 may be implemented on a single semiconductor die without changing the essence of the embodiments of the invention.

In one embodiment, the host processor 201 communicates with the second memory 202 via a host bus adaptor 209. In the embodiments discussed herein, the first memory 213 is physically closer to the processors 207 and 208 compared to the proximity of the second memory 202 from the processors 207 and 208. In one embodiment, the second memory 202 is an electro-mechanical hard-drive. In other embodiments, the second memory 202 is a solid state drive (SSD). In one embodiment, the second memory 202 is operable to store user data 205 only while the first memory 213 is operable to store system data only.

By separating the user data and the system data from the host data for closer accessibility of the system data to the processors 207 and 208, overall performance of the computer system 200 is improved. One reason for such improvement in the performance of the computer system 200 is that the system data which is frequently accessed by the processors 207 and 208, compared to the frequency of access of the user data by the processors 207 and 208, is now physically closer to the processors 207 and 208—the first memory 213 for storing the system data is integrated within the host processor 201.

In the embodiment of FIG. 2, the system data access by the processors 207 and 208 does not cause power consumption of the second memory 202 because the host processor 201 no longer has to consume energy to locate randomly placed system data from the second memory 202 as is the case in the computer system 100 of FIG. 1. This power savings from the host processor 201 contributes to the overall performance enhancement of the computer system 200.

Furthermore, additional power savings are realized by the processors 207 and 208 of the host processor 201 because the processors 207 and 208 do not send and receive system data on the buses 203, 210, and the adaptor 209. By having no system data traffic on the buses 203, 210, and the adaptor 209, input-output (I/O) transceivers associated with these buses consume less power compared with a computer system having I/O transceivers operating to send and receive system and user data on the buses 210 and 203. The additional power savings contribute to the overall performance enhancement of the computer system 200.

In one embodiment, the host processor 201 improves the bandwidth of the bus 203 for the user data because the host processor 201 is operable to send and receive the user data 205 only on the bus 203 i.e., the bus 203 no longer has to send and receive the system data from the second memory 202. Such bandwidth improvement of user data on the buses improves access time of the user data 205 for the host processor 201 and thus contributes to the overall performance enhancement of the computer system 200. Users of the computer system 200 can access the user data 205 faster than accessing the user data 105 of FIG. 1 because the host processor 201 no longer has to use the bus 203 (and associated logic) for sending and receiving system data.

In one embodiment, the host processor 201 improves reliability of the computer system 200 because the probability of loss of system data caused by losses of data in the buses 203 and 210 is eliminated—system data is no longer transmitted/received on the buses 203 and 210. An improvement in reliability of the computer system 200 also contributes to the improvement in the performance of the computer system 200.

In one embodiment, the host processor 201 is operable to boot-up from reset or wake-up from a sleep state faster than the host processor 101 of FIG. 1. One reason for such faster boot-up and wake-up times is that the system data which is used by the operating system 214 to initiate a boot-up or wake-up process no longer has to wake-up the second memory 202 to access the system data. In such an embodiment, the system data associated with boot-up or wake-up operations of the host processor 201 is accessed from the first memory 213 without having to send and receive system data to and from the second memory 202.

In one embodiment, the logic unit 211 of the microprocessor 207 is operable to monitor host data, which is processed by the microprocessor 207, to separate the system data and the user data from the monitored host data. In one embodiment, the logic unit 211 is operable to monitor the characteristics of the host data. Characteristics of the host data include size of the host data and frequency of request or use of the host data. The characteristics of the host data also include the logical block address (LBA) of the host data to be sent to the second memory 202 where the LBA represents a minimum granularity of data size that can transfer between the host processor 201 and the second memory 202. The above three characteristics are not limiting number of characteristics. In other embodiments, the logic unit 211 is operable to monitor other (non-listed) characteristics of the host data to separate the user data and system data from the host data. The size (in bytes) of the system data is generally smaller than the size of the user data. In one embodiment, the logic unit 211 is operable to monitor one or more than one of the characteristics of the host data to determine whether the host data is user data or system data.

In one embodiment, the logic unit 211 is operable to compare the size of the host data with a predetermined threshold size and to generate a comparison result. In one embodiment, if the comparison result indicates that the monitored host data is smaller than the predetermined threshold size then the monitored data is system data. In such an embodiment, the logic unit 211 informs the microprocessor 207 and/or the operating system 214 to store the host data as system data in the first memory 213. In one embodiment, if the comparison result indicates that the monitored host data is larger than the predetermined threshold size then the logic unit 211 informs the microprocessor 207 and/or the operating system 214 to store the monitored host data in the second memory 202 because the monitored host data is determined to be user data.

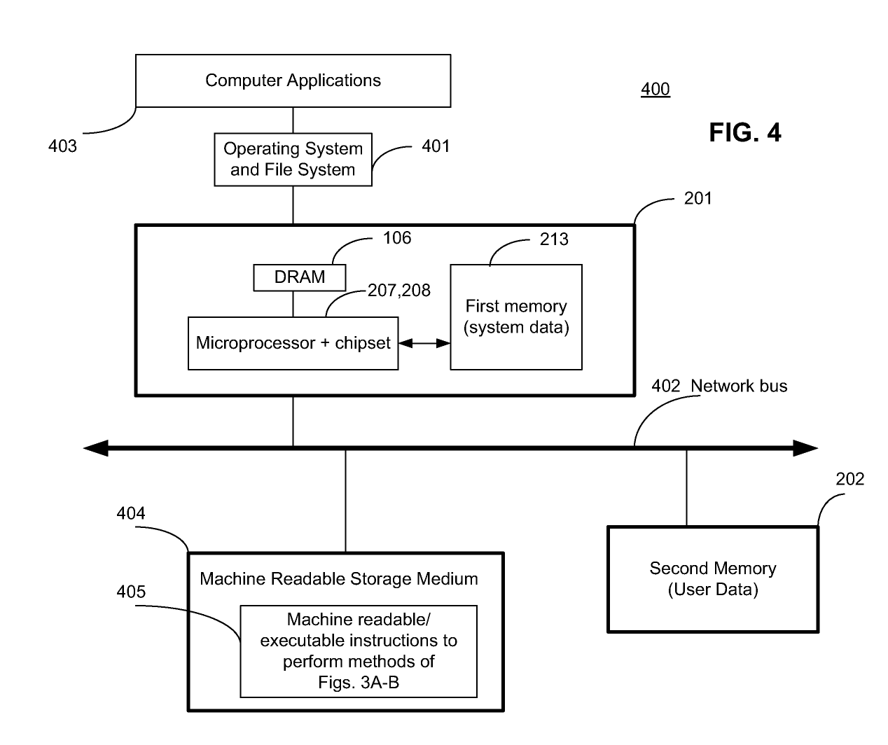

In one embodiment, the logic unit 211 is operable to instruct a software driver (not shown) to monitor the size of the host data and to compare it with a predetermined threshold size to determine whether the monitored host data is system data or user data. In one embodiment, the software driver is stored as machine-readable instructions 405 in a machine-readable storage medium 404 of FIG. 4.

In one embodiment, the logic unit 211 is operable to monitor the LBA of the host data to be sent to the second memory 202. In such an embodiment, the logic unit 211 is operable to compare the LBA with a predetermined threshold that can be determined from a File System format information. In one embodiment, the File System is a File Allocation Table 32 (FAT32) file system. In such an embodiment, the predetermined threshold is determined by calculating the first LBA after a File System Table within the FAT32 file system. While the above embodiment is explained using FAT32 file system, other file systems can use similar approaches to determine user data locations for computing the predetermined threshold.

In one embodiment, if the comparison result indicates that the LBA is less than the predetermined threshold then the host data is system data. In such an embodiment, the logic unit 211 informs the microprocessor 207 and/or the operating system 214, based on the comparison result, to store the host data as system data in the first memory 213. In one embodiment, if the comparison result indicates that the LBA is greater than the predetermined threshold then the host data is user data. In such an embodiment, the logic unit 211 informs the microprocessor 207 and/or the operating system 214 to store the host data in the second memory 202.

In one embodiment, the logic unit 211 is operable to instruct a software driver (not shown) to monitor the LBA of the host data to be sent to the second memory 202 and to compare the LBA with the predetermined threshold to determine whether the host data is system data or user data. In one embodiment, the software driver is stored as machine-readable instructions 405 in a machine-readable storage medium 404 of FIG. 4.

Referring back to FIG. 2, in one embodiment, the operating system 214 is operable to instruct the software driver to channel memory access (read and/or write operations) to the first memory 213 when the access is an access of system data. In such an embodiment, the operating system 214 is operable to instruct the software driver to channel memory access to the second memory 202 when the access is an access of user data. In one embodiment, the operating system 214 monitors the comparison result generated by the logic unit 211 and directly (without interacting with a software driver) channels system data access requests to the first memory 213 and user data access requests to the second memory 202.

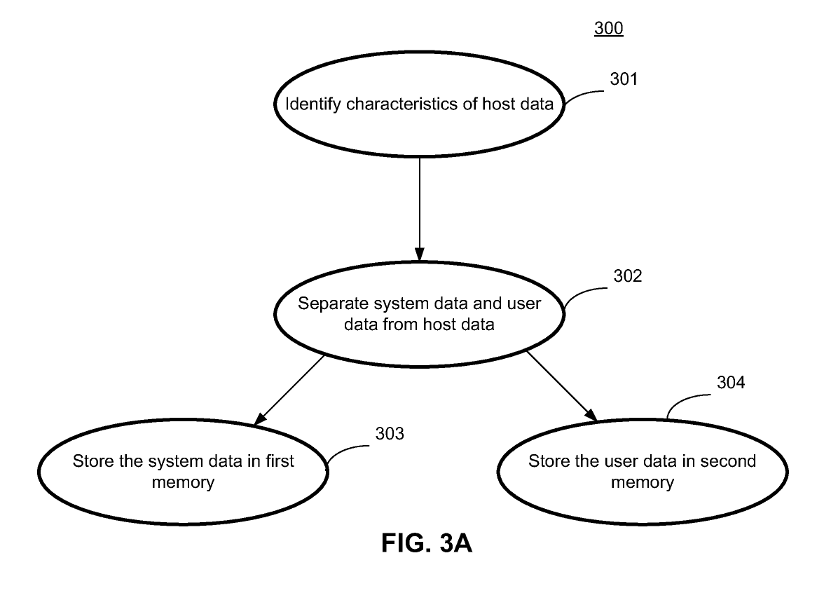

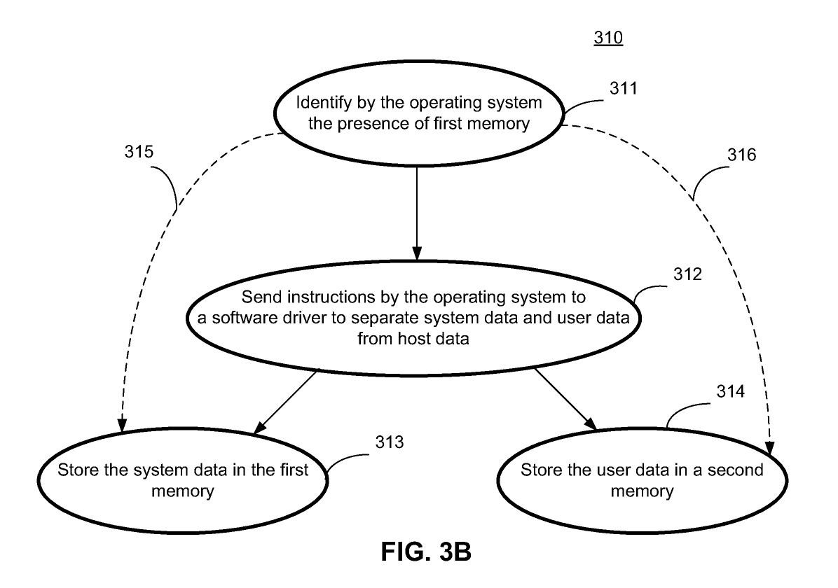

FIG. 3A illustrates a flowchart 300 to separate system and user data from host data, according to one embodiment of the invention. The flowchart 300 is described with reference to FIG. 2.

At block 301, the logic unit 211 of the microprocessor 207 monitors the host data and identifies the characteristics of the host data. In this embodiment, the characteristic of the host data is the size of the host data. In other embodiments, other characteristics, as discussed above with reference to FIG. 2, may be used in conjunction with the flowchart 300 to identify the nature of the host data i.e., whether the host data is system data or user data. In one embodiment, the flowchart 300 may use one or a combination of the characteristics to identify the nature of the host data. Characteristics of the host data include size of the host data, frequency of request or use of the host data, and the LBA of the host data to be sent to the second memory 202 where the LBA signifies a minimum granularity of data size that can transfer between the host processor 201 and the second memory 202.

At block 302, based on the identified characteristics of the host data, the logic unit 211 separates system data and user data from the host data. As discussed above, if the comparison result from the logic unit 211 indicates that the monitored host data is smaller than a predetermined threshold size then the monitored data is system data. Similarly, if the comparison result from the logic unit 211 indicates that the monitored host data is larger than the predetermined threshold size then the monitored data is user data. In one embodiment, the logic unit 211 is operable to inform the operating system 214 and/or the software driver (not shown) about the nature of the host data i.e., whether the host data is system data or user data.

At blocks 303 and 304, the operating system 214 and/or the software driver (not shown) monitors the comparison result generated by the logic unit 211 and stores the monitored data to either the first memory 213 or the second memory 202 based on the comparison result. At block 303, the operating system 214 instructs the microprocessor 207 and/or the chipset processor 208 to store the system data to the first memory 213. At block 304, the operating system 214 instructs the microprocessor 207 and/or the chipset 208 to store the user data to the second memory 202. In one embodiment, all memory accesses to the system data are channeled by the operating system 214 to the first memory 213 while all memory accesses to the user data are channeled by the operating system 214 to the second memory 202. In other embodiments, the software driver (not shown) or any other logic unit may channel memory accesses to the corresponding first and second memories based on the nature of the memory access i.e., whether the memory accesses is for system data or user data.

FIG. 3B illustrates a flowchart 310 to separate system and user data from host data, according to another embodiment of the invention. The flowchart 310 is described with reference to FIG. 2.

At block 311, the operating system 214 identifies the presence of the first memory 213 in the host processor 201. The operating system 214 being aware of the first memory 213 monitors the nature/characteristics (one or a combination of characteristics) of the host data and determines whether the host data is system data or user data. As discussed above, the operating system 214 may perform the comparison function (discussed with reference to the logic unit 211 in FIG. 2) and determines whether the host data is system data or user data. Characteristics of the host data include size of the host data, frequency of request or use of the host data, and the LBA of the host data to be sent to the second memory 202, where the LBA signifies a minimum granularity of data size that can transfer between the host processor 201 and the second memory 202.

Based on the comparison result, the operating system 214 follows the logical paths 315 and/or 316 shown as dotted lines. At block 313, the operating system follows the logical path 315 (dotted line) and stores (or instructs the microprocessor 207 to store) the system data in the first memory 213 based on the comparison result. Similarly, at block 314, the operating system follows the logical path 316 (dotted line) and stores (or instructs the microprocessor 207 to store) the user data in the second memory 202 based on the comparison result.

In an alternative embodiment, the operating system 214 follows the logical path shown by solid lines. At block 312, the operating system 214 instructs a software driver to separate the system data and user data from the host data. In such an embodiment, the operating system 214 delegates its authority of separating the system and user data from host data to the software driver. In one embodiment, the software driver implements the comparison function (discussed with reference to the logic unit 211) and determines whether the host data is system data or user data. In another embodiment, the software driver monitors the comparison result generated by the logic unit 211 and channels all memory access to system data to the first memory 213 and channels all memory access to user data to the second memory 202. At block 313 and 314, the software driver stores user data to the first memory 213 and system data to the second memory 202, respectively.

FIG. 4 illustrates a computer system 400 with machine-readable instructions 405 to execute methods discussed in the above embodiments, according to one embodiment of the invention. FIG. 4 is described with reference to FIG. 2.

In one embodiment, the computer system 400 comprises a host processor 201 communicatively coupled to the second memory 202 via a network bus 402. As discussed in FIG. 2, the host computer 201 includes a microprocessor, a chipset, and a first memory to store system data. In one embodiment, the computer system 400 further comprises an operating system 401 (same as 214 of FIG. 2) that manages computer applications 403 by separating the host data from those computer applications 403 into system data and user data. In one embodiment, the computer system 400 includes the second memory 202 to store user data only, wherein the second memory 202 is communicatively coupled to the host processor 201 via the network bus 402.

In one embodiment, the machine-readable instructions 405 are stored in a machine-readable storage medium 404 which is communicatively coupled to a host processor 201 via the network bus 402. The term “machine-readable instruction” is interchangeably referred to as “computer-executable instruction.” The computer-executable instructions include instructions to perform the methods described herein including methods of FIGS. 3A-B.

In one embodiment, the computer executable instructions include the instructions of the software driver discussed with reference to FIG. 2 and FIGS. 3A-B. The machine-readable medium may include, but is not limited to, flash memory, optical disks, CD-ROMs, DVD ROMs, RAMs, EPROMs, EEPROMs, magnetic or optical cards, or other types of machine-readable media suitable for storing electronic or computer-executable instructions. For example, embodiments of the invention may be downloaded as a computer program (e.g., BIOS) which may be transferred from a remote computer (e.g., a server) to a requesting computer (e.g., a client) by way of data signals via a communication link (e.g., a modem or network connection).

Reference in the specification to “an embodiment,” “one embodiment,” “some embodiments,” or “other embodiments” means that a particular feature, structure, or characteristic described in connection with the embodiments is included in at least some embodiments, but not necessarily in all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional element.

While the invention has been described in conjunction with specific embodiments thereof, many alternatives, modifications and variations of such embodiments will be apparent to those of ordinary skill in the art in light of the foregoing description.

For example, the logic unit 211 or its functionality may be implemented on a memory controller (not shown) that controls all access to the first and the second memories 213 and 202, respectively. In one embodiment, the operating system 214 includes logic to identify a characteristic of the host data and determines whether the host data is system data or user data based on the characteristics of the host data. The operating system 214 may then instruct the memory controller to channel all memory access of system data to the first memory 213 and to channel all memory access of user data to the second memory 202.

In one embodiment, the logic unit 211 is operable to monitor the frequency of request or use of the host data by the second memory 202. In such an embodiment, the logic unit 211 is operable to compare the frequency of request/use of the host data with a predetermined threshold frequency and to generate a comparison result. In one embodiment, if the comparison result indicates that the frequency of request/use of the host data is less than the predetermined threshold then the host data is system data. In such an embodiment, the logic unit 211 informs the microprocessor 207 and/or the operating system 214, based on the comparison result, to store the host data as system data in the first memory 213. In one embodiment, if the comparison result indicates that the frequency of request/use of the host data is greater than the predetermined threshold then the host data is user data. In such an embodiment, the logic unit 211 informs the microprocessor 207 and/or the operating system 214 to store the host data in the second memory 202. The implementation of the comparison function in the embodiments of the invention can be reversed without changing the essence of the embodiments of the invention e.g., if the frequency of request/use of the host data is less than the predetermined threshold then the host data is user data.

The embodiments of the invention are intended to embrace all such alternatives, modifications, and variations as to fall within the broad scope of the appended claims.

We claim:

1. An apparatus comprising:
a logic unit to separate system data and user data from host data, the host data to be processed by a processor;
a first memory to store the system data separated by the logic unit; and
a second memory to store the user data separated by the logic unit.

2. The apparatus of claim 1, wherein the first memory is a non-volatile memory coupled to the processor.

3. The apparatus of claim 1, wherein the first memory is a non-volatile memory comprising a NAND memory or a Phase Change Memory (PCM).

4. The apparatus of claim 1, wherein the first memory is integrated on a host processor system having the processor and a chipset processor.

5. The apparatus of claim 1, wherein the first memory is physically located closer to the processor than the second memory.

6. The apparatus of claim 1, wherein the first memory is operable to store the system data only, and wherein the second memory is operable to store the user data only.

7. The apparatus of claim 1, wherein the logic unit is operable to separate the system data and the user data from the host data by comparing a logical block address (LBA) of the host data with a predetermined threshold.

8. The apparatus of claim 1, wherein the logic unit is operable to separate the system data and the user data from the host data via a driver that is operable to determine the system data and the user data from characteristics of the host data, wherein the characteristics of the host data include size of the host data, frequency of request of the host data, and the logical block address (LBA) of the of the host data.

9. The apparatus of claim 1, wherein the logic unit is operable to separate the system data and the user data from the host data via an operating system that is operable to channel memory access to the system data via the first memory and to channel memory access to the user data via the second memory.

10. A system comprising:
a microprocessor to separate system data and user data from host data;
a chipset processor coupled to the microprocessor;
a first memory coupled to the chipset processor to store the system data separated by the microprocessor; and
a second memory coupled to the chipset processor to store the user data separated by the microprocessor.

11. The system of claim 10, wherein the first memory is a non-volatile memory coupled to the chipset processor.

12. The system of claim 10, wherein the first memory is a non-volatile memory comprising a NAND memory or a Phase Change Memory (PCM).

13. The system of claim 10, wherein the first memory is physically located closer to the chipset processor than the second memory, and wherein the microprocessor, the chipset processor, and the first memory are part of a host processor which is communicatively coupled to the second memory.

14. The system of claim 10, wherein the first memory is operable to store the system data only, and wherein the second memory is operable to store the user data only.

15. The system of claim 10, wherein the second memory is communicatively coupled to the chipset processor via a Serial Advance Technology Attachment (SATA) Interface or a Serially Attached Small System Computer (SAS) Interface.

16. The system of claim 10, wherein the microprocessor comprises a logic unit which is operable to separate the system data and the user data from the host data via an operating system that is operable to channel memory access to the system data via the first memory and to channel memory access to the user data via the second memory.

17. A method comprising:
separating system data and user data from host data;
storing the separated system data in a first memory; and
storing the separated user data in a second memory.

18. The method of claim 17, wherein the first memory is operable to store the system data only, and wherein the second memory is operable to store the user data only.

19. The method of claim 17, wherein separating the system data and the user data from the host data comprises:
channeling memory access to the system data to the first memory; and
channeling memory access to the user data to the second memory, wherein the channeling memory accesses to the system data and the user data is via an operating system.

20. The method of claim 17, wherein separating the system data and the user data from the host data comprises:
comparing a logical block address (LBA) of the host data with a predetermined threshold to generate a comparison result; and
determining whether the host data is user data or system data according to the comparison result.
